(19) United States
(12) Patent Application Publication
(10) Pub. No.: US 2006/0000081 A1
(43) Pub. Date: Jan. 5, 2006

(54) Manufacturing method for electronic device with functional thin film

(75) Inventor: Ryoji Kondo, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/159,094

(22) Filed: Jun. 23, 2005

(30) Foreign Application Priority Data
Jun. 30, 2004 (JP) 193478/2004

(51) Int. Cl. B23P 19/00; H01M 10/14

(52) U.S. Cl. 29/730

(57) ABSTRACT

An object of the present invention is to obtain uniform shape of a thin film of an electronic device having a thin film. The present invention comprises the steps of: forming an substantially linear droplet pattern by applying an ink-jet head having a plurality of nozzles which discharge a droplet of a solvent containing a functional thin-film material to provide a substrate with droplets from at least part of a plurality of the nozzles; and drying the droplets which have been provided on the substrate, the drying step is performed by intake-exhaust means which is positioned in a direction orthogonal to the substantially linear droplet pattern from the ink-jet head and which has an exhaust opening wider than the approximate linear droplet pattern.

### BACKGROUND OF THE INVENTION

1. Field of the Invention

The present invention relates to a manufacturing method for an electronic device with a functional thin film, which is applied to an image display apparatus or the like.

2. Description of the Related Art

In Japanese Unexamined Patent Publication No. Heisei 09-069334 (Unexamined European Patent Publication No. 717428A), an easy and inexpensive method is proposed for manufacturing a surface-conduction electron emission device wherein the surface-conduction electron emission device is manufactured by discharging metal-containing solvent onto a substrate in a droplet state and forming a conductive thin film. The method is shown in FIG. 6.

In FIG. 6, reference mark 1 represents a substrate, reference marks 2 and 3 represent device electrodes, reference mark 4 represents a conductive film, reference mark 5 is an electron emission portion, reference mark 7 represents a discharge head, and reference mark 24 represents a droplet, respectively. The electron emission portion 5 is formed by applying a voltage to the device electrodes 2 and 3 for power distribution.

Further, an electron source substrate where the above-mentioned electron emission devices are arrayed on a substrate 1 in a matrix, and an image forming apparatus have been manufactured.

A cross-sectional shape of a conductive thin film formed by a step wherein droplets are conventionally applied onto a substrate with low water absorption, such as a glass substrate, is greatly affected by the conditions of drying the substrate when droplets are applied, since the substrate has a low water absorption rate. In particular, as the number of droplet discharging nozzles is increased for an improvement in a takt-time, a phenomenon occurs in that droplets discharged from nozzles positioned at the ends of the nozzle array are easy to dry, and droplets discharged from nozzles positioned in the middle of the array are difficult to dry. Moreover, solvent vaporized from discharged droplets remains on the surface of the substrate, causing variation in drying periods of droplets. Therefore, the problem has arisen that the above-mentioned phenomenon causes an uneven cross-sectional shape of a film which is formed.

With regard to the problem of vaporized solvent in an ink-jet forming film, there is proposed, in Japanese Unexamined Patent Publication No. 2001-341296, corresponding to U.S. Patent Publication No. 2002/041302A, a method for removing undesired solvent vapor from a substrate surface wherein droplets are deposited while spraying dry gas.

However, the method described in JPP 2001-341296 for removing the solvent vapor by spraying gas is undesirable because the sprayed gas affects drying conditions of devices located at the surface impinged by the sprayed gas. Therefore, there is a need for a method for removing such solvent vapor more effectively.

Accordingly, it is an object of the present invention to improve uniformity of a cross-sectional shape of a film formed by an ink-jet deposition method by effectively removing solvent vapor from a surface of a substrate.

### SUMMARY OF THE INVENTION

It is an object of the present invention to improve uniformity of a cross-sectional shape of a film formed by an ink-jet method by removing solvent vapor from a surface of a substrate effectively.

In order to solve the abovementioned object, the present invention is carried out by a manufacturing method for manufacturing an electronic device with a functional thin film, comprising the steps of:
forming an approximately linear droplet pattern by providing the droplets onto a substrate from at least a part of a plurality of the nozzles with use of an ink-jet head having the plurality of nozzles which discharge the droplets of solvent containing a functional thin film materia; and
drying the droplets provided onto the substrate, wherein the drying step is performed by intake-exhaust means which is positioned in a direction orthogonal to the approximately linear droplet pattern from the ink-jet head and has an exhaust opening wider than the approximately linear droplet pattern.

Further features and advantages of the present invention will become apparent from the following description of exemplary embodiments with reference to the attached drawings.

### BRIEF DESCRIPTION OF THE DRAWINGS

FIGS. 1A and 1B are schematic views of an electron emission device formed by a manufacturing method according to the present invention.

FIGS. 2A, 2B, 2C and 2D are explanatory views schematically showing a concept of the manufacturing method for an electron emission device according to the present invention.

FIG. 3 is a schematic view showing an example of the manufacturing method for an electron emission device according to the present invention.

FIG. 4 is a schematic view showing another example of the manufacturing method for an electron emission device according to the present invention.

FIG. 5 is a schematic view showing an example of a manufacturing method for a surface-conduction electron emission device.

FIGS. 6A, 6B, 6C, and 6D are schematic views showing an example of a conventional manufacturing process for forming an electron emission device.

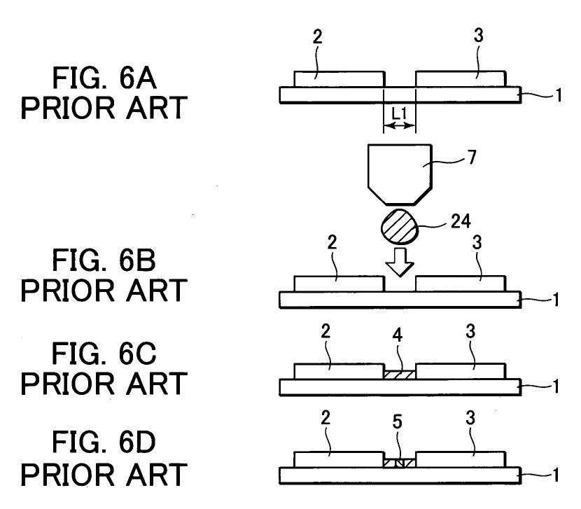

### DESCRIPTION OF THE EMBODIMENTS

Hereinafter, the present invention is described with reference to the drawings.

The method for forming a functional thin film of an image forming apparatus is a method for forming a film such as an electric field emission device, an organic EL device, and a color filter, which are formed by an ink-jet method. In particular, a surface-conduction electron emission device is a favorable mode which is applied in the invention, since the electron emission characteristic thereof is grealy affected by the cross-sectional shape of the film.

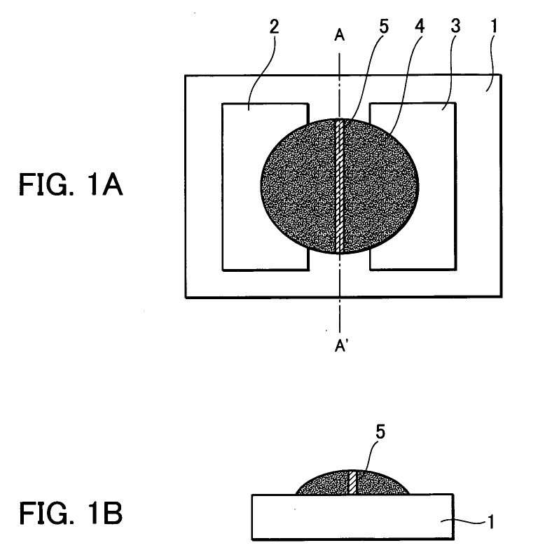

FIGS. 1A and 1B are schematic views showing an example of a flat surface-conduction electron emission device according to an embodiment in the present invention.

In FIGS. 1A and 1B, reference mark 1 represents a substrate with low water absorbing rate such as a glass substrate, reference marks 2 and 3 represent device electrodes, reference mark 4 represents a conductive thin film, and reference mark 5 represents an electron emission portion. Suitable materials and general configurations of the above constituents once formed employing the instant invention are disclosed in Japanese Unexamined Patent Publication No. Heisei 09-069334 stated above.

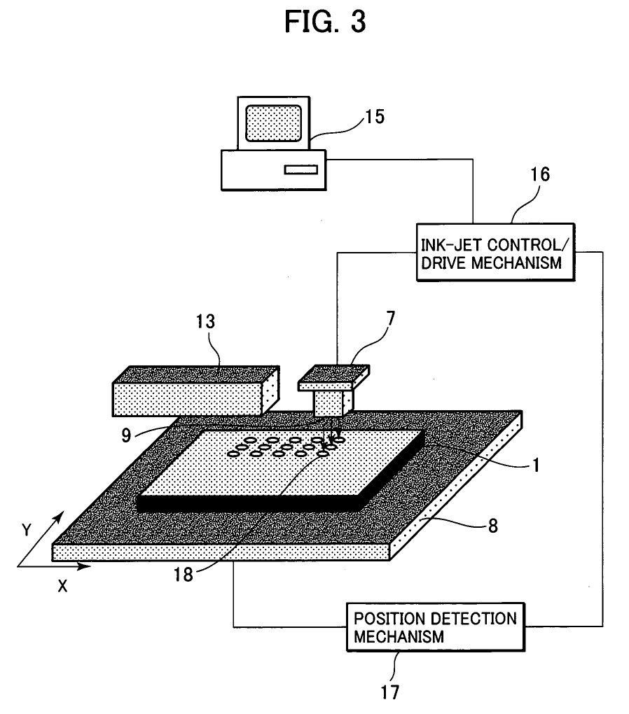

FIG. 3 is a schematic view showing an example of a process, in the manufacturing method according to the present invention, for forming a conductive thin film by discharging a solvent containing a precursor of a functional film on a substrate.

In FIG. 3, a discharge head 7 is installed above the substrate 1 placed on a substrate stage 8, and the solvent is discharged from a plurality of discharge nozzles 9 incorporated on the discharge head 7 to be applied to the substrate 1. Intake-exhaust means 13 is installed in a direction orthogonal to the array direction of the nozzle on the discharge head 7, and droplets 8 applied onto the substrate are dried by the intake-exhaust means 13 after application.

The discharge head 7 is provided with an ink-jet control/drive mechanism 16, and this mechanism can apply droplets to the intended position on the substrate by discharging the droplets in conjunction with a position detection mechanism 17 and a stage drive mechanism (not shown) provided in the stage 8.

The series of control are performed by a control computer 15.

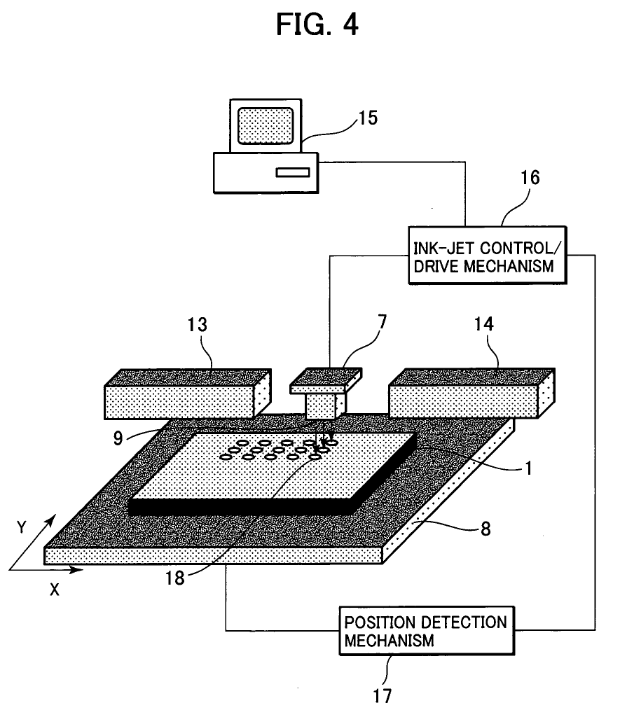

In case that droplets are serially provided onto the substrate 1, the intake-exhaust means 13 is spaced so that the droplets 18 which are provided by scanning of the substrate or the head are moved below the undersurface of the exhaust means by scanning of the substrate or the head just after being provided. FIG. 3 shows an arrangement relation in the case where droplets are provided while the substrate is scanned to the left (in the negative direction on the X-axis) of the head. When scanning is carried out in both direction (in the negative and positive direction on the X-axis), two exhaust means are provided at symmetrical positions on both sides of the head as illustrated in FIG. 4.

In addition, the droplet providing mechanism described in FIG. 3 is maintained in an environment of constant temperature and constant humidity by an environment management apparatus (not illustrated).

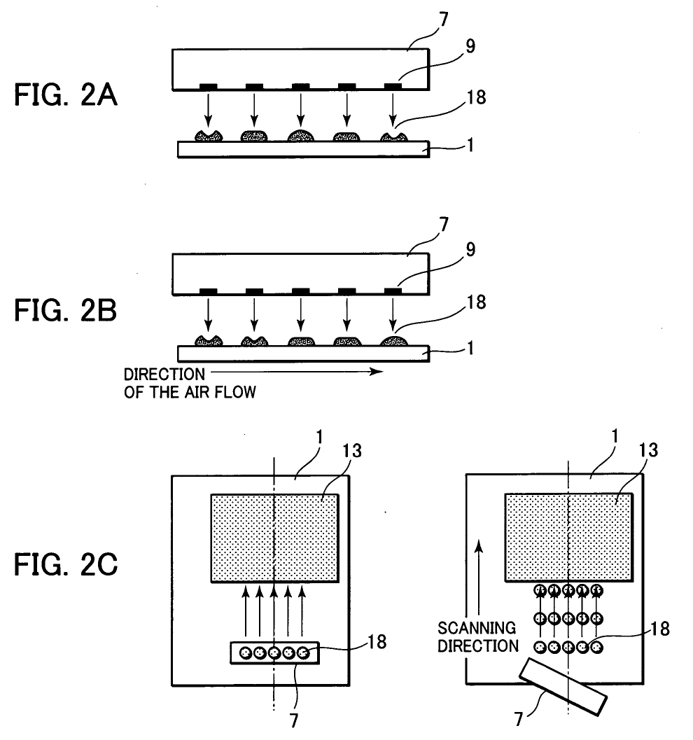

Hereinafter, drying of ink-jet droplets by the intake-exhaust means, which is a characteristic of the present invention, is described with reference to FIGS. 2A, 2B, 2C and 2D. FIG. 2A shows a case where no intake-exhaust means is present. Reference mark 7 represents a discharge head which discharges droplets 18 onto a substrate 1 from a plurality of nozzles 9. Droplets provided from nozzles, outside the nozzle group are less affected by the volatile solvent from adjacent droplets. Therefore, droplets provided from nozzles positioned outside the nozzle group dry faster than the droplets provided by nozzles positioned in the middle of the nozzle group. Since a cross-sectional shape of the film where droplets have been provided is affected by the drying speed of the droplets, the droplets provided by a plurality of nozzles differ in cross-sectional shape between the center and exterior of the nozzle group. Moreover, as shown in FIG. 2B, due to the air flow occuring around an apparatus and/or the air flow occuring when a head or a substrate is moved, a distribution of cross-sectional shapes of the film may be generated along the direction of the air flow. The reason for this distribution of cross-sectional shapes of the film is believed to be that upstream droplets dry quickly, whereas downstream droplets dry slowly owing to an influence of the volatile solvent from the upstream droplets. If a film which is uneven in the cross-sectional shape is used as a functional film in a display apparatus, the display characteristics become uneven and the quality of the display apparatus is impaired.

Accordingly, as a result of research conducted for improving uniformity of a film while enhancing a takt-time by using a pluraility of nozzles, there has been found a method for providing an intake-exhausting (or exhaust) means near the head and exhausting the solvent component of the droplets provided from a plurality of nozzles in a direction orthogonal to the nozzle array direction from the moment the droplet is provided or, more accuretely, in a direction orthogonal to a deposited pattern (a substantially linear droplet pattern). As a result, the variation of the influence of the volatile solvent on each droplet is reduced and uniformity of the film is thus improved. More specifically, instead of being dispersed by air blasting, which is a positive flow of air, volatile solvent is removed by suction and exhaust (or a negative flow of air). Therefore, conditions for drying droplets can be the same at any position on a substrate. As a result, the uniformity of a shape of a functional film is improved.

FIG. 2C shows an example of a positional relation between the intake-exhaust means and the head. FIG. 2C shows a view seen vertically from above the plane of the substrate 1 onto which droplets are provided. In FIG. 2C, reference mark 7 represents the head, and reference mark 18 represents droplets deposited on the substrate from nozzles on head 7. Reference mark 13 represents intake-exhaust means. Here, the intake-exhaust means 13 is a box having a rectangular shape with an opening on the surface side of the substrate. In addition, an exhaust blower (not illustrated) and a vacuum pump are connected to the box so that air is exhausted into the opening from the surface of the substrate. The intake-exhaust means 13 is installed in a direction orthogonal (or perpendicular) to arrays of the nozzles on the head and, more accurately, in a direction orthogonal to a deposited droplet pattern.

An airflow rate near the droplets 18 generated by the intake-exhaust means 13 is designed so that the volatile solvent of the droplets 18 can be exhausted in a direction orthogonal to the nozzle array direciton from the moment the droplets 18 are deposited on the substrate 1. Therefore, influences of volatile solvent on the respective droplets from the plurality of nozzles can be reduced. The shape of the intake-exhaust means is not limited to a rectangular parallelpiped and may be any other suitable shape as long as the distribution of air flow rate generated by the exhaust means is consistent among the plurality of nozzles. As shown by a dashed line in FIG. 2C, it is preferable that a positional relation between the intake-exhaust means and the plurality of nozzles is such that the center of each is on the same line.

Moreover, it is desirable that the width of the intake-exhaust opening of the intake-exhaust means is broader (or wider) than the width of the droplet pattern (substantially linear droplet pattern provided about at once), and, more preferably, the former is twice as wide as the latter. Therefore, air flow is conducted toward the exhaust opening in a direction orthogonal to the droplet pattern. Accordingly, exhaust conditions at the edge and center portion of the droplet pattern become uniform, and the droplets are dried under more uniform conditions. Consequently, uniformity of the cross-sectional shape of the film is improved. In other words, the present invention provides intake-exhaust means in a direction orthogonal to a longitudinal direction of a discharged droplet pattern formed from a plurality of nozzles to control drying of the droplets by an exhaust stream.

To enhance uniform drying of the droplets, the width of the exhaust opening is longer than the width of the droplet pattern. Any air flow rate generated by the exhaust near the nozzles is permissible as long as (i) the volatile solvent is sufficiently removed and (ii) the droplet flight trajectory from an ink-jet head is not significantly bent. It is preferable that the air flow rate just below the head is at least 0.1 m/s in order to enhance uniformity of the shape of a film.

Further, when a head or a substrate is scanned relative to each other to serially provide droplets on the substrate, the head may be tilted around a normal line of the substrate so that a nozzle pitch of the head is aligned with a pitch of drawing portions on the substrate. In such a case, the intake-exhaust means is provided in a direction of a scanning axis at the time of discharging droplets from the head as shown in FIG. 2D. It is preferable that scanning is performed so that all droplets provided pass below the intake-exhaust means 13 while scanning, because uniformity in the scanning axis direction is improved.

Furthermore, the number of the heads is not limited to one. Where a plurality of heads are used, intake-exhaust means may be provided for each head. Exhaust conditions at the edge and center of a discharge pattern can, thereby, be made more uniform and the droplets dry under more uniform conditions. As a result, uniformity of the pattern shape is improved. In other words, it is a feature of the present invention to provide intake-exhaust means in a direction orthogonal to a length of a droplet pattern and to control drying of the droplets by exhaust flow when forming a pluraity of droplets continuously in a short period of time by scanning the substrate or the head in a direction orthogonal to a length of a droplet pattern.

### Embodiment 1

An electron source substrate having multiple surface-conduction electron emission devices was manufactured using a substrate where wiring and device electrodes were formed into a matrix.

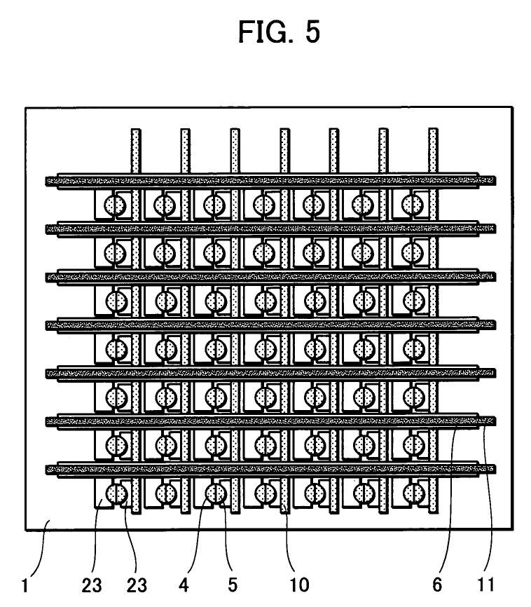

Hereinafter, descriptions are provided with references to FIGS. 3 and 5.

A glass substrate was used as an insulating substrate 1. After being sufficiently washed with an organic solvent, the substrate 1 was dried at 120° C. On substrate 1, a pair of device electrodes, each with an electrode width of 500 μm and an electrode interval of 20 μm was formed in a matrix manner being composed of 240 columns and 720 rows and 172800 sets in total, using a PT film, and wiring was connected to the device electrodes, respectively. For this wiring, matrix wiring as shown in FIG. 5 was employed.

After the glass substrate was washed with an alkaline cleaning liquid, surface treatment was performed on the glass substrate using a silane-based water repellent agent.

Thereafter, the glass substrate was positioned on a stage 8 installed within a temperature- and humidity-controlled chamber. In the chamber the temperature was set at 25° C. and the humidity at 45%, and a pattern alignment was carried out (see FIG. 3).

Further, solvent containing a material of a conductive thin film 4 was poured into a discharge head 7 as ink. The solvent used was an organic palladium-containing solvent.

Then, while the stage 8 was being scanned in the −X direction at a rate of 100 mm/s, discharge signals were simultaneously transmitted to nozzles 9 according to the designed discharge timing and droplets were discharged through a position detection mechanism 17 and an ink-jet control/drive mechanism 16, so that the organic palladium-containing solvent was gradually provided between the device electrodes on the substrate. There were four nozzles which discharged droplets simultaneously. Since a nozzle pitch of the head and a droplet pattern pitch on the substrate are identical, the head was positioned so that a nozzle array direction became orthogonal to the scanning axis of the substrate. At this time, an exhaust flow was initiated so as to generate an airflow of 0.3 m/s near the head, using intake-exhaust means 13. The shape of the intake-exhaust means was a rectangular parallelepiped with a side in the scanning direction of 200 mm, a side in the nozzle array direction of 80 mm, which was longer than the drawing pattern, and a height of 40 mm. Droplets were provided only when the substrate was scanned in the −X direction (in the negative direction on the X-axis in FIG. 3), and were not provided when the substrate was scanned in the +X direction.

The substrate was heated at 350° C. for 30 minutes and a palladium oxide film was obtained.

Further, a voltage was applied between the electrodes 2 and 3, and an electron emission portion 5 was formed by forming and activating a conductive thin film 4.

When evaluating the uniformity of the group of electron emission devices formed in this embodiment, using electric resistance of the films, a coefficient of variation thereof was 3.5%. On the other hand, a coefficient of variation of electric resistance of a group of electron emission devices having a similar constitution to that of this embodiment, but not having been subjected to exhaust drying, was 10.0%. This shows that the exhaust feature improves the uniformity of the film.

The electron source substrate manufactured as above was combined with a faceplate, a support frame and the like to make a display panel. Further, driving circuits were connected to the display panel to form an image forming apparatus exhibiting superior uniformity and at a high yield. Although a glass substrate was used in this embodiment, the invention can be applied to other various substrates having a low water absorption rate. For example, the present invention can also be applied to a substrate wherein a surface of a glass substrate was coated with a film having low water absorption rate (a silicon dioxide film or the like).

### Embodiment 2

This embodiment is similar to that of Embodiment 1, except that droplets were provided when a substrate was scanned in both directions, −X direction and +X direction as shown in FIG. 4 in order to further improve productivity. For this purpose, intake-exhaust means 13 and 14 were installed symmetrically to to the head as shown in FIG. 4.

On evaluating the in-plane uniformity of the group of electron emission devices manufactured in this embodiment, using electric resistance of the films, the coefficient of variation was 3.5%. On the other hand, a coefficient of variation of electric resistance of a group of electron emission devices having a similar constitution to that of this embodiment but not having been subjected to the exhaust drying of this invention was 10.0%. This shows that the novel exhaust feature improved the uniformity of the film.

The electron source substrate manufactured as above was combined with a faceplate, a support frame to make a display panel, and, further, driving circuits were connected to the display panel to form an image forming apparatus. The image forming apparatus was superior in uniformity and was manufactured in a high yield.

According to the present invention, it is possible to provide a uniform shape of a plurality of functional thin films while reducing the takt-time. As a result, costs are reduced and more uniform performance of an electronic device are provided.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-193478 filed Jun. 30, 2004, which is hereby incorporated by reference herein.

What is claimed is:

1. A manufacturing method for an electronic device having a functional thin film, comprising the steps of:
forming a substantially linear droplet pattern by providing the droplets onto a substrate from at least part of a plurality of the nozzles with the use of an ink-jet head having a plurality of nozzles which discharge the droplets of solvent containing a functional thin film material; and
drying the droplets provided onto the substrate, wherein the drying step is performed by intake-exhaust means which is positioned in a direction orthogonal to the substantially linear droplet pattern from the ink-jet head and has an exhaust opening wider than the approximately linear droplet pattern.

2. A manufacturing method for an electronic device according to claim 1,
wherein a width of the exhaust opening of the intake-exhaust means is at least twice as long as a length of the substantially linear droplet pattern.

3. A manufacturing method for an electronic device according to claim 1, wherein
the step of forming the droplet pattern is performed while at least either of the substrate or the ink-jet head is scanned in a direction which is not parallel to the substantially linear droplet pattern.

4. A manufacturing method for an electronic device according to claim 1, wherein
the electronic device is an electron emission device.

5. A manufacturing method for an electronic device according to claim 1, wherein
the electronic device is an organic EL device.
